(19) United States
(12) Patent Application Publication
(10) Pub. No.: US 2026/0077562 A1
(43) Pub. Date: Mar. 19, 2026

(54) METHOD FOR HEAT-SEALING A SEAL ON A PLASTIC CONTAINER

(71) Applicant: 1/4 VIN, Solliès-Pont (FR)

(72) Inventors: Christian MURA, Ceyreste (FR); Pascal CARVIN, Solliès-Pont (FR)

(21) Appl. No.: 18/848,409

(22) PCT Filed: Mar. 17, 2023
(86) PCT No.: PCT/FR2023/050377

§ 371 Date: May 20, 2025

(30) Foreign Application Priority Data
Mar. 21, 2022 (FR) FR2202478

(51) Int. Cl. B29C 65/00; B29L 31/00; B65D 77/20

(52) U.S. Cl. CPC B29C 66/24221; B29C 66/11; B29C 66/30223; B29C 66/322; B29C 66/53461; B29C 66/73921; B29C 66/832; B65D 77/2024; B29L 2031/7132

(57) ABSTRACT

A method for heat sealing a lid on a thermoplastic drinking glass comprising a wall with an upper end having a rim comprising an annular rib and two collecting surfaces extending on either side of the annular rib. According to the invention, the rim also comprises first and second annular grooves extending between the annular rib and the collecting surfaces. The method comprises, during the heat sealing of the lid, a step of making all or part of the annular rib flow into the grooves.

### CROSS-REFERENCE TO RELATED APPLICATIONS

This application is a 371 National Stage of International Application No. PCT/FR2023/050377, filed Mar. 17, 2023, which claims priority to French Patent Application No. FR2202478, filed Mar. 21, 2022, the disclosures of which are herein incorporated by reference in their entirety.

### TECHNICAL FIELD

The present invention relates to a method for heat sealing a lid on a thermoplastic container and a thermoplastic container for the implementation of this method. The container has a rim permitting the sealing of the lid. The rim consists of an annular rib and two collection surfaces extending in a lower plane on either side of the annular rib.

### BACKGROUND

FIG. 1 shows an example of the general shape of a container in the form of a thermoplastic drinking glass 1. The drinking glass includes a rim 10 forming the upper part of the drinking glass on which the lips rest. FIG. 2 shows in cross-sectional view a profile of the rim 10 as described in patent EP 2408 688. The rim 10 comprises an annular rib 13 and two collection surfaces 16, 18 extending on either side of the annular rib 13. The annular rib 13 consists of a central upper part 14 and two lateral lower parts 15, 17 extending below the central part 14 above the collection surfaces 16, 18. The upper part 14 and the lower lateral parts 15, 17 of rib 13, as well as the collection surfaces 17, 18 extend in roughly parallel planes and present a general symmetry of revolution along a vertical longitudinal axis AA′ of the drinking glass.

The heat sealing of a lid 50 on drinking glass 1 is carried out by means of a metal heating head 60 applied to the lid 50 and exerting pressure on the rim 10, as shown in FIG. 4A. In a first step shown in this figure, the upper center part 14 of rib 13 begins to melt under the heat and pressure exerted by the heating head 60. It flows and spreads over the lower lateral parts 15, 17 of the rib, the whole then forming a bulge 140 in which the upper central part 14 and the lower lateral parts 15, 17 of the rib 13 are no longer distinguishable.

If the heat-sealing process is stopped at this point, the fusion of the central upper part 14 ensures a minimal, albeit imperfect, sealing of the lid. For this reason, the central upper part 14 is called a “fuse”: it guarantees that the lid will be sealed from the first moment of the sealing process. However, to obtain a perfect seal, the process should be continued to a step shown in FIG. 4B, in which the bulge 140 has continued to flow and spreads at least partially over the collection surfaces 17, 18.

Once this step has been reached, it is preferable not to continue the sealing process, otherwise, after spreading over the collection surfaces 16,18, the bulge 140 will overflow beyond them, forming a burr that can be sharp, which extends in a horizontal plane, inside and outside the drinking glass.

In other words, the flow process should extend beyond a minimum time Tmin1 where only fuse 14 has been melted, without exceeding a maximum time Tmax beyond which rib 13 has excessively flowed and forms a sharp burr. These times Tmin1 and Tmax depend on various parameters and more specifically on the pressure and temperature applied to the lid, as well as the time of the heat-sealing process and the pressure in the drinking glass, which tends to increase with temperature and can cause leaks in the seal.

The applicant has years of experience in the industrial-scale development of this heat-sealing process and has found, in some cases, that a sharp burr develops despite the fact that the time Tmax has not been exceeded. Studies have shown that under certain conditions, the bulge 140, before reaching the final state shown in FIG. 4B, passes through an intermediate state shown schematically in FIG. 5, in which it has two protrusions 141, 142 oriented towards the inside and the outside of the drinking glass. These protrusions are intended to disappear and spread over the collection areas 16,18. However, if the flow process is stopped too early, the protrusions 141, 142 remain and may be sharp, although not extending beyond either side of the rim. As a result, when the user removes the lid, they can cut their lips or even their fingers.

To eliminate this risk, the flow process should be continued for a minimum time Tmin2 greater than Tmin1, beyond which the protrusions 141, 142 disappear, always without exceeding the time Tmax. This constraint reduces the tolerance to achieve a perfect seal, which is defined by the time interval Tmin2−Tmax. This time interval may be very short in practice, on the order of a few tenths of a second to a second. Due to tolerances on process parameters, it may be difficult to ensure that under all circumstances, the sealing process is stopped at the appropriate time corresponding to a non-protruding bulge as shown in FIG. 4B.

To increase the operating margin and to more easily overcome errors related to the tolerances of the sealing process, it is possible to increase the time interval between Tmin2 and Tmax by slowing down the melting and flow of the rim. For this purpose, for example, a silicone layer may be placed between the heating head and the lid, which slows down the heat transfer to the rim. However, this solution has the disadvantage of imposing a temperature of the heating head that is higher than that which would be necessary in the absence of the silicone layer.

It may therefore be desirable to omit this silicone layer for better temperature transfer, energy savings thanks to a lower temperature of the heating head, and cost reduction of the heat-sealing process because the silicone layer is a consumable that often needs to be replaced.

More generally, it may be desirable to improve the process of sealing the lids described above in order to avoid the risk of appearance of the above-mentioned protrusions.

### SUMMARY

To this end, the present invention provides a thermoplastic container comprising with an upper end having a rim comprising (i) an annular rib comprising a central upper surface, a first lateral surface and a second lateral surface and (ii) two collection surfaces extending on either side of the annular rib, wherein the rim also comprises first and second annular grooves extending between the annular rib and the collection surfaces and recessed from the collection surfaces, so that all or part of the annular rib flows into the annular grooves when a lid is heat-sealed on the rim.

According to an embodiment, the first lateral surface and the second lateral surface of the annular rib extend below the central upper surface and above the collection surfaces.

According to an embodiment, the first annular groove is located on the outer side of the container, the second annular groove is located on the inner side of the container and has a radial width greater than that of the first annular groove.

According to an embodiment, the first collection surface is located on the outer side of the container, the second collection surface is located on the inner side of the container and has a radial width greater than that of the first collection surface.

According to an embodiment, the collection surfaces and the central upper surface of the annular rib are substantially rounded in shape.

According to an embodiment, the rim has a radial width between 2 and 4 millimeters.

According to an embodiment, the annular grooves have a depth of the order of one tenth of a millimeter to five tenths of a millimeter below the collection surfaces, and a radial width of the order of one tenth of a millimeter to five tenths of a millimeter.

Embodiments of the invention also relate to a method for heat sealing a lid on a rim of a thermoplastic container, the rim comprising (i) an annular rib comprising a central upper surface, a first lateral surface and a second lateral surface, and (ii) two collection surfaces extending on either side of the annular rib, wherein the rim also comprises first and second annular grooves extending between the annular rib and the collection surfaces and recessed from the collection surfaces, the method comprising, during heat sealing of the lid, a step of making all or part of the annular rib flow into the grooves.

According to an embodiment, the first lateral surface and the second lateral surface of the annular rib extend below the central upper surface and above the collection surfaces.

According to an embodiment, the first lateral surface of the annular rib is located on the outer side of the container, the second lateral surface of the annular rib is located on the inner side of the container and has a radial width greater than that of the first lateral surface of the annular rib.

According to an embodiment, the first annular groove is located on the outer side of the container, the second annular groove is located on the inner side of the container and has a radial width greater than that of the first annular groove.

According to an embodiment, the first collection surface is located on the outer side of the container, the second collection surface is located on the inner side of the container and has a radial width greater than that of the first collection surface.

According to an embodiment, the rim has a radial width between 2 and 4 millimeters, the annular grooves have a depth of the order of one tenth of a millimeter to five tenths of a millimeter below the collection surfaces, and a radial width of the order of one tenth of a millimeter to five tenths of a millimeter.

Embodiments of the invention also relate to a method for making a thermoplastic wine glass containing wine and sealed by a lid, the method comprising a step of manufacturing the drinking glass, a step of filling the drinking glass with wine, and a step of heat sealing the lid on the drinking glass rim according to the method of the invention described above.

### BRIEF DESCRIPTION OF THE DRAWINGS

Examples of implementation of a container in the shape of a drinking glass and of a heat sealing process according to the invention will be described in the following without limitation in relation to the attached figures, among which:

FIG. 1, previously described, shows a thermoplastic drinking glass comprising a rim with a conventional profile,

FIG. 2, previously described, shows a profile of the drinking glass rim,

FIG. 3 shows dimensions of the rim profile,

FIGS. 4A, 4B, previously described, show an initial and a final step of a conventional sealing method of a lid on the rim,

FIG. 5, previously described, shows an intermediate step in the conventional sealing method,

FIG. 6 shows a thermoplastic drinking glass comprising a rim according to an embodiment the invention,

FIG. 7 is a top view of the rim in FIG. 6,

FIG. 8 is a cross-sectional view of the rim in FIG. 6,

FIG. 9 shows a lid designed to be sealed on the rim in FIG. 6,

FIG. 10 shows dimensions of the rim profile in FIG. 6,

FIG. 11 shows an initial step in a sealing method according to the invention of the lid on the rim in FIG. 6,

FIG. 12 shows an intermediate step of the sealing method according to the invention,

FIG. 13 shows another intermediate step of the sealing method according to the invention,

FIG. 14 shows a final step of the sealing method according to the invention, and

FIG. 15 is a flow chart of a method for making a sealed wine glass according to the sealing method of the invention.

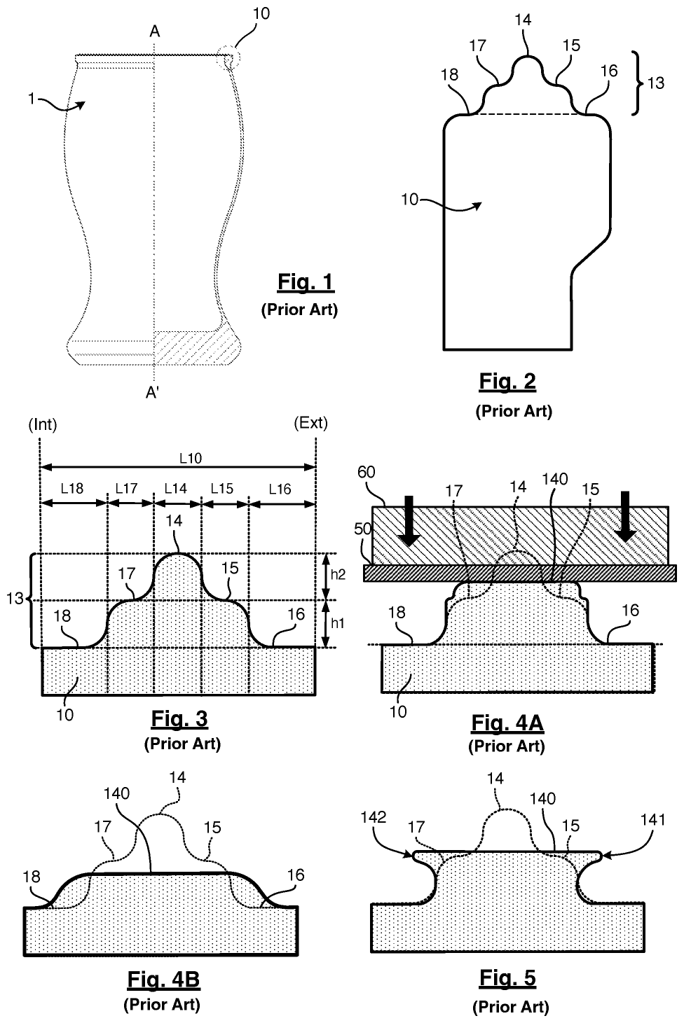

### DETAILED DESCRIPTION

FIG. 6 shows a thermoplastic drinking glass 100 comprising a rim 20 according to the invention. FIG. 7 is a top view of the rim 20 and FIG. 8 is a cross-sectional view of the rim 20. In FIG. 7, the rim has a diameter D which is not to scale for reasons of legibility of this figure. This diameter D is in practice of the order of a few centimeters, while the radial width L of the rim is of the order of a few millimeters.

With reference to FIG. 8, the rim 20 comprises an inner face 21 corresponding to the inner face of the funnel of the drinking glass 100, and an outer face 22 projecting from the outer face of the funnel, forming a protruding annular collar. This collar 22 may be used as a support to receive the end of a gripping tool, for handling the drinking glass or its blank during manufacture. This manufacture is preferably achieved by injection-blow molding, and includes a step of injection into a mold of a thermoplastic polymer, in particular polyethylene terephthalate (PET), to obtain a blank, then a step of blowing the blank to obtain the drinking glass 100.

According to the invention, the rim 20 comprises an annular rib 23 bordered by two annular collection grooves 30, 31 provided on either side of the rib 23. Groove 30—or outer groove—is arranged on the outer side of the drinking glass 100, while groove 31—or inner groove—is arranged on the inner side of the drinking glass 100.

The rim also includes, on either side of grooves 30, 31, two annular collection surfaces 26, 28 which border grooves 30 and 31. Surface 26—or outer collection surface—runs along the outer groove 30 while surface 28—or inner collection surface—runs along inner groove 31.

In an embodiment, rib 23 includes, in a conventional manner, a central upper part 24 and two lateral lower parts 25, 27 extending from the central part 24 in a lower plane above the grooves 30, 31 and the collection surfaces 26, 28. The surfaces of the lower lateral parts 25, 27 of rib 23 will be referred to in the following as “lower lateral surfaces” 25, 27 of rib 23. The surface of the upper part 24 will be referred to in the following as the “central upper surface” 24 of rib 23. The collecting surfaces 26, 28 as well as the lower lateral surfaces 25, 27 and the upper surface 24 of rib 23 have a general symmetry of revolution about the vertical longitudinal axis AA′ of the drinking glass 100 (FIG. 6).

Collection surfaces 26, 28, lower lateral surfaces 25, 27 of rib 23, and upper surface 24 of rib 23 are ideally substantially flat and will be considered as such in the following, for sake of simplicity. However, due to the injection blow molding process, some of these surfaces may in practice be somewhat rounded as shown in FIGS. 8, 10, 12 to 14. The method of the invention and the advantages it produces are not, in any event, dependent on the flat or rounded shape of these surfaces.

FIG. 10 shows the profile 200 of the rim 20 and the arrangement of surfaces 24 to 28, 30, 31 in planes substantially parallel and perpendicular to the vertical longitudinal axis AA′ of the drinking glass (assuming that these surfaces are substantially flat). Collection surfaces 26, 28 extend in a plane P0, lateral surfaces 25, 27 of rib 23 extend in a plane P1, and the upper surface 24 of rib 23 extends in a plane P2. The plane P1 extends above the plane P0 at a height h10. The plane P2 extends above the plane P1 at a height h20. The bottoms of grooves 30, 31 extend in a plane G0 located below the plane P0 at a depth g10. The difference in height dh between the bottom of the grooves 30, 31 (plane G0) and the lower lateral surfaces 25, 27 of the rib (plane P1) is here equal to the sum of the height h10 and the depth g10, while the difference in height between the bottom of the grooves 30, 31 (plane G0) and the collection surfaces 25, 27 (plane P0) is equal to the height h10. In an embodiment, the heights h10, h20 and depth g10 are of the order of a tenth of a millimeter to five tenths of a millimeter.

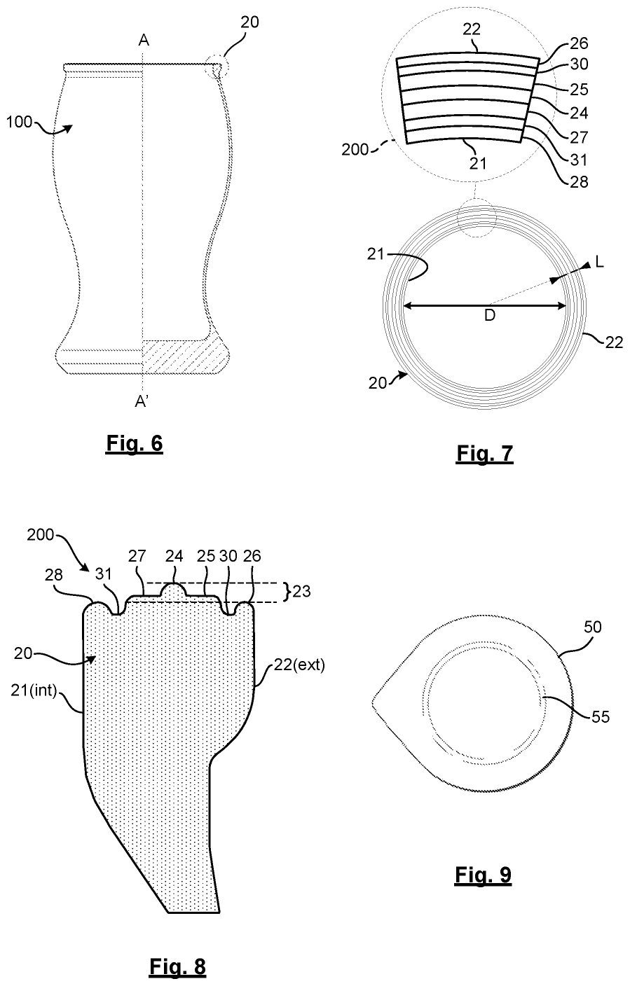

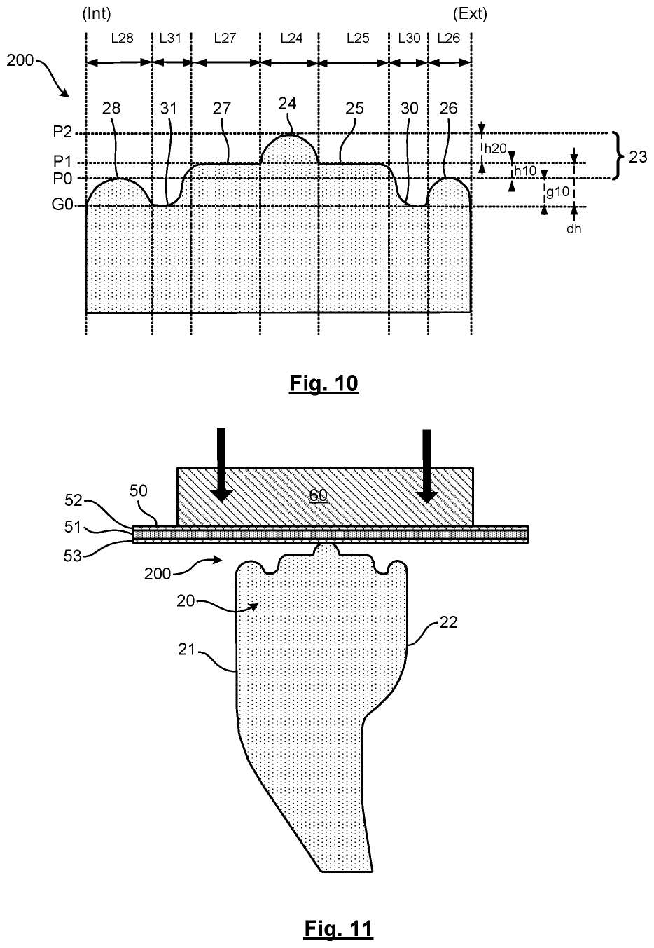

FIG. 9 is a top view of a lid 50 designed to be heat-sealed on the rim 20, the sealing being carried out in an annular zone 55 of the lid, corresponding to the location of the rim. FIG. 11 shows the positioning of a heating head 60 above the rim 20 with the lid 50 interposed. The lid may include a metallic core layer 51, e.g. an aluminum layer with a thickness of 30 to 60 micrometers. The upper surface of layer 51, facing the heating head 60, may be coated with a layer 52 such as a lacquer or a plastic film, e.g. a polyester film. The underside of layer 51, facing rim 20, may be coated with a layer 53 such as a heat-sealing lacquer.

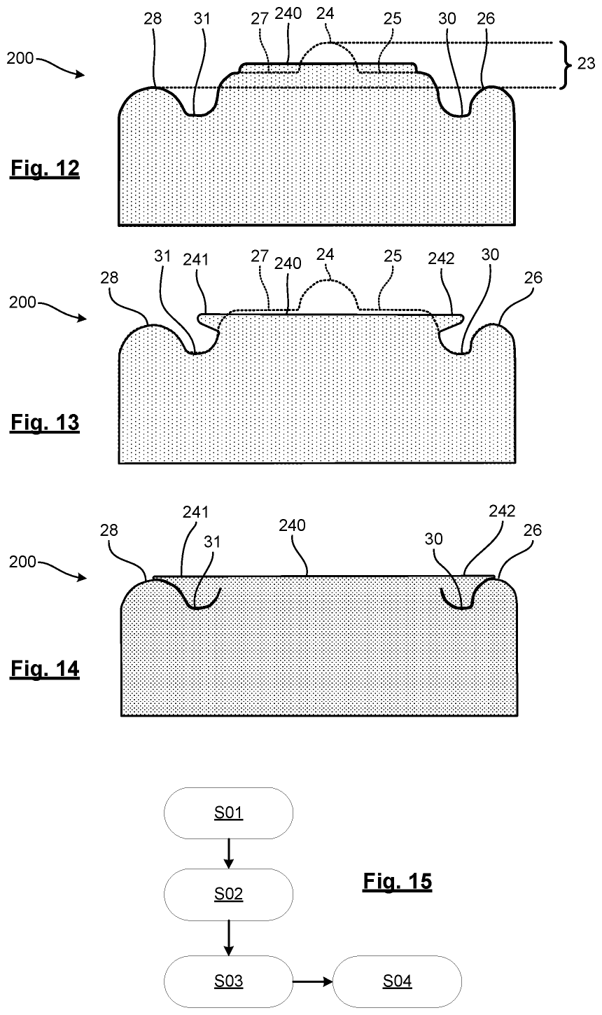

FIGS. 12, 13 and 14 show steps of the heat sealing process according to the invention. For the sake of legibility of these figures, the heating head and the lid are not shown.

In a first step shown in FIG. 12, the upper central part 24 of rib 23 begins to melt under the heat and pressure exerted by the heating head. It flows and spreads over the lateral surfaces 25, 27 of the rib, the whole then forming a bulge 240 in which the upper central part 24 and the lateral surfaces 25, 27 are no longer distinguishable.

During a step shown in FIG. 13, the bulge 240, under pressure, continues to flow and spread towards the collection surfaces 26, 28 forming two ends 241, 242 facing inward and outward from the drinking glass, which extend above the collection grooves 30, 31.

In a step shown in FIG. 14, the bulge 240 is completely flattened by the pressure exerted by the heating head and the ends 241, 242, which increased in volume due to the flow of the bulge material, are lodged in the collection grooves 30, 31. At this point, the top surface of the rim is very close to the collection surfaces 26, 28. If the sealing process is continued for a longer period of time, a very small amount of the bulge material 240 may eventually flow onto the collection surfaces 26, 28, but not far enough to extend beyond the rim and form a sharp burr. Thus, the collection grooves 30, 31 according to the invention constitute a reception volume preventing the bulge 240 from reaching the collection surfaces 26, 28 during its flow, and at the very least preventing most of the material forming the bulge from reaching the collection surfaces 26, 28. Obviously, the process cannot be continued inconsiderately, because at a certain point the entire surface of the rim could leak and cause sharp burrs to appear. The sealing process can therefore be continued until the ends 241, 242 are received by the collection grooves, thus eliminating the risk of forming sharp edges as in the known process (FIG. 5, ends 141, 142) while delaying the moment when excessive flow would cause the thermoplastic material to overflow beyond the rim 20.

Tables 1 and 2 below provide, by way of non-limiting examples, dimensions expressed in millimeters of the different parts of the profile 200 of the rim 20 as shown in FIG. 10. For comparison, these tables also provide exemplary dimensions of a profile of a conventional rim 10 as shown in FIG. 3.

In FIG. 10, the references L24, L25, L27 designate the radial widths of the different surfaces 24, 25, 27 of rib 23. References L30 and L31 designate the radial widths of collection grooves 30 and 31. References L26 and L28 denote the radial widths of collection surfaces 26 and 28. As mentioned above, reference h10 refers to the difference in height between the lower lateral surfaces 25, 27 of rib 23 and the collection surfaces 26, 28. The reference h20 designates the difference in height between the upper surface 24 of rib 23 and its lower lateral surfaces 25, 27. The reference g10 designates the depth of collection grooves 30, 31. The reference dh designates the difference in height between the bottom of the grooves 30, 31 and the lower lateral surfaces 25, 27 of the rib 23.

In FIG. 3, references L16 and L18 denote the radial widths of collection surfaces 16 and 18. References L15 and L17 refer to the radial widths of the lateral lower parts 15 and 17 of rib 13. The reference L14 designates the radial width of the central upper part 14 of rib 13. Reference h1 denotes the difference in height between the surfaces of the lower lateral parts 15, 17 and the collection surfaces 16, 18. The reference h2 designates the difference in height between the central upper part 14 and the surfaces of the lower lateral parts 15, 17 of rib 13.

The comparison of the exemplary and non-limiting dimensions indicated in Table 1 shows that for a constant radial width of the rim equal here to 2.7 mm, the location of grooves 30, 31 is found by reducing the radial widths L25, L27 of the lateral surfaces 25, 27 of rib 23 and/or by reducing the radial widths L26, L28 of the collection areas 26, 28. Furthermore, according to a design rule which is apparent from Table 1 and combines with the previous rule, the radial width L27 of the lower lateral surface 27 of rib 23, which is on the side of the inner face of the rim, is greater than the radial width L25 of the lower lateral surface 25 of rib 23, which is on the side of the outer face of the rim. This width imbalance offers a compensation for the difference in the average diameter of these surfaces so that their respective total surfaces are approximately equal. For the same reason, the radial width L28 of the collection surface 28, which is located on the side of the inner face of the rim, is greater than the radial width L26 of the collection surface 26, which is located on the side of the outer face of the rim. In an embodiment, collection grooves 30 and 31 may also have different radial widths, so that their respective collection volumes are substantially equal.

TABLE 1

| | |
|---|---|
| FIG. 3 | FIG. 10 |

| | | | |
|---|---|---|---|
| L18 | 0.68 | L28 | 0.34 |
| — | — | A31 | 0.40 |
| L17 | 0.55 | L27 | 0.49 |
| L14 | 0.40 | L24 | 0.40 |
| L15 | 0.55 | L25 | 0.35 |
| — | — | L30 | 0.40 |
| L16 | 0.52 | L26 | 0.32 |
| Total | 2.7 | Total | 2.7 |

Finally, the comparison of the exemplary and non-limiting dimensions shown in Table 2 reveals that the difference in height dh between the bottom of the grooves and the lower lateral surfaces 25, 27 of the rib 23 is equal to the difference in height h1 between the surfaces of the lower lateral parts 15, 17 and the collection surfaces 16, 18 of the profile of rim 10 according to the prior art. Thus, the thermoplastic material sees substantially the same difference in level when it flows towards the inner and outer edges of the rim. As a result, the collection surfaces 26, 28 of the profile 200 of rim 20 according to the invention rather form barriers against flow of the thermoplastic material beyond the collection grooves 30, 31, than collection surfaces strictly speaking, the term “collection surface” having been kept in the present disclosure only by analogy with the prior art.

TABLE 2

| | |
|---|---|
| FIG. 3 | FIG. 10 |

| | | | |
|---|---|---|---|
| | | h10 | 0.1 |
| | | g10 | 0.2 |
| H1 | 0.3 | DH (H10 + G10) | 0.3 |
| H2 | 0.2 | h20 | 0.2 |

The method according to the invention offers, in comparison with the method of the prior art, various other advantages. In particular, it allows the sealing process to be implemented without coating the heating head with a layer of silicone, and thus improves the heat transfer to the rim. The temperature of the heating head may be lowered to around 180-190° C., for example, instead of 220-230° C., which saves energy. The sealing process time may be reduced to about 1.8 to 2 seconds instead of 2.4 seconds, resulting in improved manufacturing yields and additional energy savings by reducing heating time. As a further advantage, the reduction in heat sealing time reduces the thermal expansion in the drinking glass of the neutral gas mixture in which the sealing is carried out, e.g. a mixture of carbon dioxide (CO2), nitrogen and Argon, and thus eliminates the risk of seal leakage due to excessive expansion of the gas.

The method of the invention may also be implemented, with the same advantages, by using a non-heating heat sealing head and an induction heating of the lid, in the presence of a magnetic field that excites the metal atoms and causes them to heat. In this case, the heat sealing head only ensures the application of the heat sealing pressure, while the heat is generated in situ in the lid.

The method of the invention is particularly well suited for industrial-scale production of heat-sealed thermoplastic wine glasses containing wine. Such an industrial manufacturing process for drinking glasses containing wine is illustrated in FIG. 15. This method comprises a step S01 for making a drinking glass 100, a step S02 for filling the drinking glass with wine, and a step S03 for heat-sealing according to the invention. These steps are followed by a step S04 of packaging and transport to points of sale or distribution. As mentioned above, the manufacturing step S01 is preferably done by injection-blow molding, and includes a step of injection into a mold of a thermoplastic polymer, in particular polyethylene terephthalate (PET), to obtain a blank, then a step of blowing the blank to obtain the drinking glass. The heat sealing step is carried out in a controlled atmosphere comprising neutral gases, e.g. a mixture of carbon dioxide (CO2), nitrogen and Argon.

It will become clear to those skilled in the art that the present invention is susceptible of various alternatives, in particular with regard to the shape, arrangement and relative positions of the different surfaces of the annular rib and the collecting surfaces, and is also fit for various applications. According to an alternative, rib 23 may also be fitted with shallow grooves to reduce the amount of material it contains and thus further reduce the heat sealing time. In other applications, the method may be used to seal a lid on a container other than a drinking glass, receiving wine or another type of liquid. Thus, the term “drinking glass” in the present application is not restrictive and refers to a container receiving a liquid.

1. A thermoplastic container comprising a wall with an upper end having a rim, the rim comprising:
an annular rib having a central upper surface, a first lateral surface and a second lateral surface, and
two collecting surfaces extending on either side of the annular rib, the first lateral surface and the second lateral surface of the annular rib extending below the central upper surface and above the collecting surfaces,
wherein the rim also comprises first and second annular grooves extending between the annular rib and the collecting surfaces and recessed from the collecting surfaces, so that all or part of the annular rib flows into the annular grooves when a lid is heat-sealed on the rim.

2. The container according to claim 1, wherein the first lateral surface of the annular rib is located on an outer side of the container, and the second lateral surface of the annular rib is located on an inner side of the container and has a radial width greater than that of the first lateral surface of the annular rib.

3. The container according to claim 1, wherein the first annular groove is located on an outer side of the container, and the second annular groove is located on an inner side of the container and has a radial width greater than that of the first annular groove.

4. The container according to claim 1, wherein a first collection surface is located on an outer side of the container, and the second collecting surface is located on an inner side of the container and has a radial width greater than that of the first collection surface.

5. The container according to claim 1, wherein the collecting surfaces and the central upper surface of the annular rib are substantially rounded in shape.

6. The container according to claim 1, wherein the rim has a radial width between 2 and 4 millimeters.

7. The container according to claim 1, wherein the annular grooves have a depth of one tenth of a millimeter to five tenths of a millimeter below the collecting surfaces, and a radial width of one tenth of a millimeter to five tenths of a millimeter.

8. A method for heat sealing a lid on a rim of a thermoplastic container, the rim comprising:
an annular rib including a central upper surface, a first lateral surface and a second lateral surface, and
two collection surfaces extending on either side of the annular rib,
wherein the rim also comprises first and second annular grooves extending between the annular rib and the collection surfaces and recessed from the collection surfaces, and
the method comprising, during a heat-sealing step of the lid, a step of making all or part of the annular rib flow into the grooves,
wherein the first lateral surface and the second lateral surface of the annular rib extend below the central upper surface and above the collection surfaces.

9. The method according to claim 8, wherein the first lateral surface of the annular rib is located on an outer side of the container, and the second lateral surface of the annular rib is located on an inner side of the container and has a radial width greater than that of the first lateral surface of the annular rib.

10. The method according to claim 8, wherein the first annular groove is located on an outer side of the container, and the second annular groove is located on an inner side of the container and has a radial width greater than that of the first annular groove.

11. The method according to claim 8, wherein a first collection surface is located on an outer side of the container, and a second collection surface is located on an inner side of the container and has a radial width greater than that of the first collection surface.

12. The method according to claim 8, wherein the rim has a radial width between 2 and 4 millimeters, and the annular grooves have a depth of one tenth of a millimeter to five tenths of a millimeter below the collection surfaces, and a radial width of one tenth of a millimeter to five tenths of a millimeter.

13. A method for making a thermoplastic drinking glass (100) containing wine and sealed with a lid, the method comprising:
a step of manufacturing the drinking glass,
a step of filling the drinking glass with wine, and
a step of heat sealing the lid on a rim of the drinking glass according to the method of claim 8.

14-15. (canceled)
